(19) United States
(12) Patent Application Publication
(10) Pub. No.: US 2026/0291384 A1
(43) Pub. Date: Sep. 24, 2026

(54) RESONANT POWER CONVERSION CIRCUIT FOR DISCHARGING RESONANT CAPACITOR AND CONTROL METHOD THEREOF

(71) Applicant: Richtek Technology Corporation, Zhubei City (TW)

(72) Inventors: Tzu-Chen LIN, Zhubei City (TW); Ta-Yung YANG, Taoyuan City (TW); Hsin-Yi WU, Zhubei City (TW)

(21) Appl. No.: 19/438,836

(22) Filed: Jan. 2, 2026

Related U.S. Application Data
(60) Provisional application No. 63/776,344, filed on Mar. 24, 2025.

(30) Foreign Application Priority Data
Sep. 5, 2025 (TW) 114134039

(51) Int. Cl. H02M 3/00; H02M 1/00; H02M 1/32; H02M 1/36; H02M 3/335

(52) U.S. Cl. CPC H02M 3/01; H02M 1/0009; H02M 1/0058; H02M 1/32; H02M 1/36; H02M 3/33571

(57) ABSTRACT

A power conversion circuit includes a transformer, a resonant capacitor, a high-side transistor, a low-side transistor, and a control circuit. The transformer includes a primary coil and a secondary coil, where the primary coil is coupled between the switch node and the resonant node. The resonant capacitor is coupled between the resonant node and the ground. The high-side transistor provides an input voltage to the switch node based on a high-side driving signal. The low-side transistor couples the switch node to the ground based on a low-side driving signal. The control circuit operates in a normal mode to generate the high-side driving signal and the low-side driving signal, so that the secondary coil generates an output voltage. When the control circuit operates in a discharge mode, the control circuit discharges the resonant capacitor with a discharge current using the low-side transistor.

### CROSS REFERENCE TO RELATED APPLICATIONS

This application claims the benefit of U.S. Provisional Application No. 63/776,344, filed on Mar. 24, 2025, the entirety of which is incorporated by reference herein.

This application claims priority of Taiwan Patent Application No. 114134039, filed on Sep. 5, 2025, the entirety of which is incorporated by reference herein.

### BACKGROUND OF THE INVENTION

### Field of the Invention

The disclosure is generally related to a power conversion circuit and a control method thereof, and more particularly it is related to a resonant power conversion circuit for discharging a resonant capacitor, and a control method thereof.

### Description of the Related Art

With the continuous advancements being made in portable electronic devices, the development of power conversion circuits, like most power products, is trending toward high efficiency, high power density, high reliability, and low cost. Since resonant power conversion circuits (which include LLC resonant power conversion circuits, flyback power conversion circuits, and others) are high-efficiency and high-power density power conversion circuits, the power conversion circuits used in portable electronic devices are gradually moving towards resonant power conversion circuits.

However, there are still many defects with the resonant power conversion circuits currently in use, so it is necessary to further optimize resonant power conversion circuits.

### BRIEF SUMMARY OF THE INVENTION

The present invention provides a power conversion circuit and a control method thereof. When the voltage across the resonant capacitor does not match the output voltage, the resonant capacitor may be discharged through the low-side transistor, helping to reduce the maximum primary current of the primary coil and the maximum output current of the secondary coil. This reduces the conduction losses of the low-side transistor and the rectification transistor, which in turn improves the conversion efficiency under low output voltage and light load conditions. At the same time, it can help to prevent surges in the secondary coil, protecting the circuit components from burnout.

In an embodiment, a power conversion circuit comprises a transformer, a resonant capacitor, a high-side transistor, a low-side transistor, and a control circuit. The transformer comprises a primary coil and a secondary coil, wherein the primary coil is coupled between a switching node and a resonant node. The resonant capacitor is coupled between the resonant node and a ground. The high-side transistor provides an input voltage to the switching node based on a high-side driving signal. The low-side transistor couples the switching node to the ground based on a low-side driving signal. The control circuit operates in a normal mode to generate the high-side driving signal and the low-side driving signal so that the secondary coil generates an output voltage. When the control circuit operates in a discharge mode, the control circuit discharges the resonant capacitor via the low-side transistor with a discharge current.

According to an embodiment of the present invention, when the control circuit receives the input voltage, the control circuit executes a startup procedure. During the startup procedure, the control circuit operates in the discharge mode to discharge the resonant capacitor. After the startup procedure, the control circuit operates in the normal mode to generate the output voltage from the secondary coil.

According to an embodiment of the present invention, when the control circuit executes a protection mechanism to simultaneously turn off the high-side transistor and the low-side transistor, the control circuit operates in the discharge mode to discharge the resonant capacitor.

According to an embodiment of the present invention, the power conversion circuit further comprises a current detection circuit. The current detection circuit is configured to detect a primary current flowing through the primary coil and the resonant capacitor to generate a current detection signal. When the control circuit operates in the discharge mode, the control circuit controls the discharge current to be less than a predetermined current based on the current detection signal.

According to an embodiment of the present invention, the current detection circuit further comprises a first detection resistor. The first detection resistor is coupled between the resonant capacitor and the ground. A voltage across the first detection resistor generates the current detection signal.

According to an embodiment of the present invention, the current detection circuit further comprises an isolated transformer and a second detection resistor. The isolated transformer comprises an isolated primary coil and an isolated secondary coil. The second detection resistor is coupled to both terminals of the isolated secondary coil. The isolated primary coil is coupled between the resonant capacitor and the ground. A voltage across the second detection resistor generates the current detection signal.

According to an embodiment of the present invention, the control circuit further comprises a current control circuit and a selection switch. The current control circuit generates a discharge signal based on the relationship between the current detection signal and a reference voltage. The selection switch provides either the low-side driving signal or the discharge signal to the low-side transistor. When the control circuit operates in the discharge mode, the selection switch provides the discharge signal to the low-side transistor. When the control circuit operates in the normal mode, the selection switch provides the low-side driving signal to the low-side transistor.

According to an embodiment of the present invention, the current control circuit adjusts the discharge signal to control the discharge current to be less than the predetermined current. When the control circuit operates in the discharge mode, the low-side transistor operates in a linear region.

According to an embodiment of the present invention, the current control circuit further comprises an error amplifier, a first control resistor, and a second control resistor. The error amplifier comprises a positive input terminal, a negative input terminal, and an output terminal. The first control resistor is coupled between the current detection signal and the positive input terminal. The second control resistor is coupled between the positive input terminal and the reference voltage. The output terminal generates the discharge signal. The negative input terminal is coupled to the ground.

According to an embodiment of the present invention, the control circuit further comprises a voltage detection circuit. The voltage detection circuit is configured to detect a voltage across the resonant capacitor to generate a voltage detection signal. The voltage detection circuit comprises a first voltage-dividing resistor and a second voltage-dividing resistor. The first voltage-dividing resistor is coupled to the resonant node. The second voltage-dividing resistor is coupled between the first voltage-dividing resistor and the ground. A voltage across the second voltage-dividing resistor generates the voltage detection signal.

According to an embodiment of the present invention, when the control circuit operates in the discharge mode, the control circuit determines whether to stop discharging the resonant capacitor based on the relationship between the voltage detection signal and the output voltage. When the control circuit determines to stop discharging the resonant capacitor, the selection switch provides the low-side driving signal to the low-side transistor.

According to an embodiment of the present invention, the control circuit determines the relationship between the voltage across the resonant capacitor and the output voltage based on the voltage detection signal. When a voltage across the resonant capacitor is less than a product of the output voltage and a turns ratio, the control circuit exits the discharge mode. When the voltage across the resonant capacitor is not less than the product of the output voltage and the turns ratio, the control circuit continues in the discharge mode. The turns ratio is equal to number of turns of the primary coil divided by number of turns of the secondary coil.

According to an embodiment of the present invention, when the control circuit operates in the discharge mode over a predetermined period, the control circuit exits the discharge mode to stop discharging the resonant capacitor. When the control circuit operates in the discharge mode, the control circuit intermittently turns on the low-side transistor to control a temperature of the low-side transistor.

In another embodiment, a control method for controlling a power conversion circuit is provided. The power conversion circuit comprises a resonant capacitor coupled between a resonant node and a ground, a transformer comprising a primary coil and a secondary coil, a high-side transistor providing an input voltage to a switching node, and a low-side transistor coupling the switching node to the ground. The primary coil is coupled between the switching node and the resonant node, wherein the control method comprises the following steps. A determination is made as to whether to operate in a normal mode or a discharge mode. The high-side transistor and the low-side transistor are driven to generate an output voltage from the secondary coil when it is determined to operate in the normal mode. The resonant capacitor is discharged via the low-side transistor with a discharge current when it is determined to operate in the discharge mode.

According to an embodiment of the present invention, the step of determining whether to operate in the normal mode or the discharge mode further comprises the following steps. Before operating in the normal mode, it is operated in the discharge mode.

According to an embodiment of the present invention, the step of determining whether to operate in the normal mode or the discharge mode further comprises the following steps. When the input voltage is received, a startup procedure is executed. During the startup procedure, the discharge mode is operated. When the startup procedure ends, the normal mode is operated.

According to an embodiment of the present invention, the step of determining whether to operate in the normal mode or the discharge mode further comprises the following steps. When executing a protection mechanism to simultaneously turn off the high-side transistor and the low-side transistor, the discharge mode is operated. When the protection mechanism ends, the normal mode is operated.

According to an embodiment of the present invention, the step of discharging the resonant capacitor via the low-side transistor with the discharge current when it is determined to operate in the discharge mode further comprises the following steps. The discharge current is detected to generate a current detection signal. The low-side transistor is controlled based on the current detection signal so that the discharge current is less than a predetermined current.

According to an embodiment of the present invention, the step of discharging the resonant capacitor via the low-side transistor with the discharge current when it is determined to operate in the discharge mode further comprises the following steps. A discharge signal is generated based on a relationship between the current detection signal and a reference voltage using an error amplifier. The low-side transistor is controlled using the discharge signal so that the discharge current is less than the predetermined current. The low-side transistor operates in a linear region when it is determined to operate in the discharge mode.

According to an embodiment of the present invention, the step of discharging the resonant capacitor via the low-side transistor with the discharge current when it is determined to operate in the discharge mode further comprises the following steps. A voltage across the resonant capacitor is detected to generate a voltage detection signal. It is determined whether to continue to discharge the resonant capacitor based on a relationship between the voltage across the resonant capacitor and the output voltage. The resonant capacitor is stopped discharging when the voltage across the resonant capacitor is less than a product of the output voltage multiplied by a turns ratio. When the voltage across the resonant capacitor is not less than the product of the output voltage multiplied by the turns ratio, the resonant capacitor continues to discharge. The turns ratio is equal to a number of turns of the primary coil divided by a number of turns of the secondary coil.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a circuit diagram of a power conversion circuit in accordance with an embodiment of the present invention;

FIG. 2 shows a waveform diagram of a power conversion circuit in accordance with an embodiment of the present invention;

FIG. 3 shows a circuit diagram of a power conversion circuit in accordance with another embodiment of the present invention;

FIG. 4 shows a circuit diagram of a power conversion circuit in accordance with yet another embodiment of the present invention;

FIG. 5 shows a circuit diagram of a power conversion circuit in accordance with yet another embodiment of the present invention;

FIG. 6 shows a circuit diagram of a power conversion circuit in accordance with yet another embodiment of the present invention; and

FIG. 7 shows a flowchart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

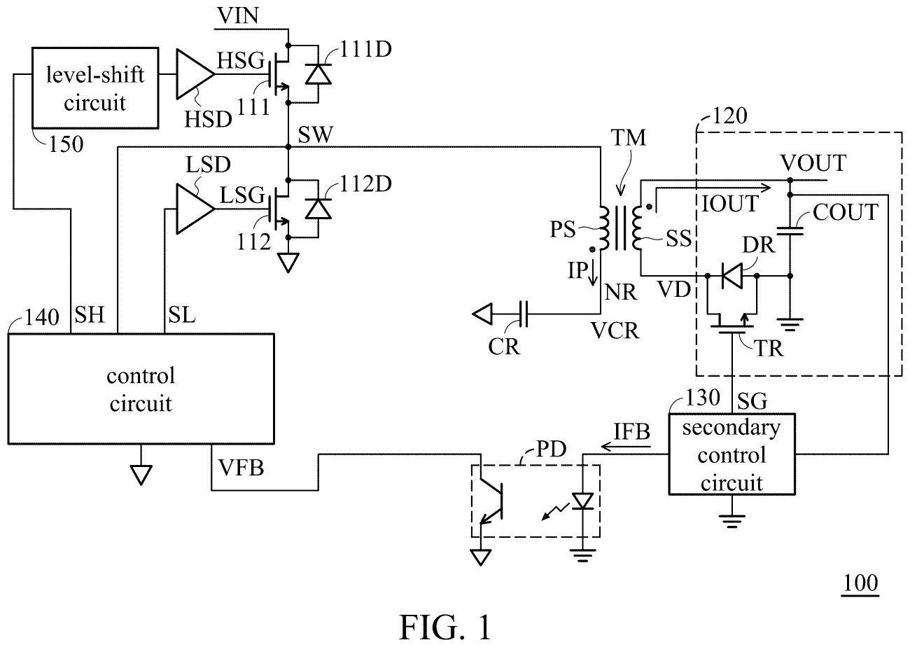

FIG. 1 shows a circuit diagram of a power conversion circuit in accordance with an embodiment of the present invention. As shown in FIG. 1, the power conversion circuit 100 includes a high-side transistor 111, a low-side transistor 112, a resonant capacitor CR, a transformer TM, a rectification circuit 120, a secondary control circuit 130, an optocoupler PD, a control circuit 140, a level-shift circuit 150, a high-side driving circuit HSD, and a low-side driving circuit LSD.

The high-side transistor 111 provides the input voltage VIN to the switching node SW based on the high-side gate driving signal HSG. According to an embodiment of the present invention, the high-side transistor 111 includes a high-side parasitic diode 111D, where the high-side parasitic diode 111D is coupled between the switching node SW and the input voltage VIN. The low-side transistor 112 couples the switching node SW to ground based on the low-side gate driving signal LSG. According to an embodiment of the present invention, the low-side transistor 112 includes a low-side parasitic diode 112D, wherein the low-side parasitic diode 112D is coupled between the switching node SW and the ground.

A resonant capacitor CR is coupled between the resonant node NR and the ground, and a resonant voltage VCR is generated across the resonant capacitor CR. The transformer TM includes a primary coil PS and a secondary coil SS. The primary coil PS is coupled between the switching node SW and the resonant node NR. The output current IOUT generated by the secondary coil SS is rectified by the rectification circuit 120 to generate an output voltage VOUT.

According to some embodiments of the present invention, the primary coil SS and the resonant capacitor CR are connected in series between the switching node SW and the ground. In other words, the resonant capacitor CR may also be coupled between the switching node SW and the resonant node NR, and the primary coil PS may be coupled between the resonant node NR and the ground.

The rectification circuit 120 converts the output current IOUT generated by the secondary coil SS into an output voltage VOUT, and includes a rectification transistor TR and an output capacitor COUT. According to some embodiments of the present invention, the rectification transistor TR further includes a rectification parasitic diode DR. The rectification transistor TR is turned on based on a gate signal SG, causing the output current IOUT from the secondary coil SS to charge the output capacitor COUT, thereby generating the output voltage VOUT. When the rectification transistor TR is turned off, the voltage across the drain terminal and source terminal of the rectification transistor TR is the drain voltage VD.

The secondary control circuit 130 generates a feedback current IFB based on the output voltage VOUT, where the feedback current IFB generates a feedback voltage VFB via an optocoupler PD. The secondary control circuit 130 further uses the gate signal SG to turn on the rectification transistor TR, causing the output current IOUT generated by the secondary coil SS to charge the output capacitor COUT, thereby generating the output voltage VOUT.

The control circuit 140 generates a high-side driving signal SH and a low-side driving signal SL based on the feedback voltage VFB. The level-shift circuit 150 shifts the voltage level of the high-side driving signal SH to the input voltage VIN. The high-side driving circuit HSD generates a high-side gate driving signal HSG based on the shifted signal to drive the high-side transistor 111. The low-side driving circuit LSD generates a low-side gate driving signal LSG based on the low-side driving signal SL to drive the low-side transistor 112.

According to some embodiments of the present invention, the control circuit 140 further generates the high-side driving signal SH and the low-side driving signal SL based on the voltage of the switching node SW, so that both the high-side transistor 111 and the low-side transistor 112 achieve zero-voltage switching (ZVS), thereby improving the conversion efficiency of the power conversion circuit 100. According to some embodiments of the present invention, the power conversion circuit 100 may be a resonant power conversion circuit. According to some embodiments of the present invention, the power conversion circuit 100 may be a resonant flyback power conversion circuit. According to some embodiments of the present invention, the power conversion circuit 100 may be an asymmetrical half-bridge flyback power converter.

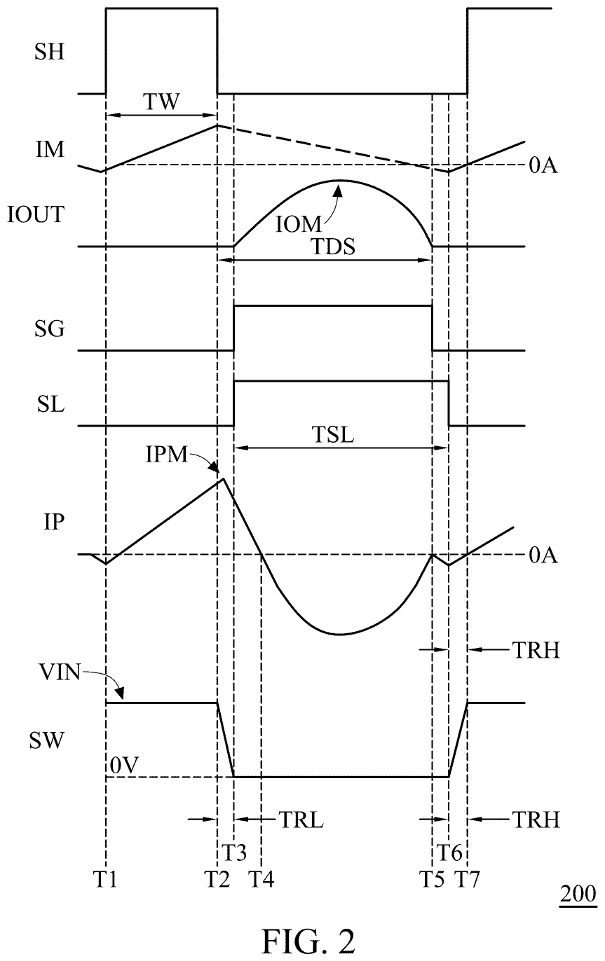

FIG. 2 shows a waveform diagram of a power conversion circuit in accordance with an embodiment of the present invention. The following description related to the waveform 200 will be provided in conjunction with the power conversion circuit 100 in FIG. 1 for detailed explanation. From a first time point T1 to a second time point T2, the high-side transistor 111 is turned on based on the high-side driving signal SH (i.e., high logic level), where the high-side conduction period TW is the conduction period of the high-side transistor 111. During the high-side conduction period TW, the transformer TM is magnetized, generating a magnetizing current IM. As the conduction time TW increases, the magnetizing current IM of the transformer TM, the primary current IP flowing through the primary coil PS, and the resonant voltage VCR all continuously increase. In other words, the high-side conduction period TW is the magnetization period of the transformer TM.

When the high-side transistor 111 is turned off (i.e., the high-side driving signal SH is at a low logic level), the transformer 10 demagnetizes. During the demagnetization period TDS, the transformer 10 generates an output current IOUT, and the conduction period of the low-side transistor 112 (i.e., the low-side driving signal SL is at a high logic level) corresponds to the demagnetization period TDS. According to some embodiments of the present invention, the low-side conduction period TSL of the low-side driving signal SL is equal to or greater than the demagnetization period TDS. During the demagnetization period TDS, the voltage across the primary coil PS is equal to the resonant voltage VCR, and the output voltage VOUT is as shown in Eq. 1:

$$V C R = n \times VOUT \qquad ( Eq . 1 )$$

$$n = \frac{N P}{N S}$$

NP represents the number of turns in the primary coil PS, NS represents the number of turns in the secondary coil SS, and the turns ratio n is the number of turns in the primary coil PS divided by the number of turns in the secondary coil SS.

The demagnetization period TDS is as shown in Eq. 2:

$$T D S = \frac{( VIN - VCR ) \times TW}{n \times VOUT} \qquad ( Eq . 2 )$$

When the high-side transistor 111 is turned on, (VIN−VCR) is the voltage used to magnetize the transformer TM.

At the second time point T2, the high-side driving signal SH transitions to a low logic level to turn off the high-side transistor 111. At the third time point T3, the low-side driving signal SL transitions to a high logic level to turn on the low-side transistor 112. According to some embodiments of the present invention, the first dead time TRL from the second time point T2 to the third time point T3 is the dead time from the high-side transistor 111 turning off to the low-side transistor 112 turning on. According to some embodiments of the present invention, from the second time point T2 to the third time point T3, the primary current IP reaches the maximum primary current IPM.

According to some embodiments of the present invention, during the first dead time TRL, the circulating current generated by the primary coil PS turns on the low-side parasitic diode 112D, pulling down the voltage of the switching node SW, causing the low-side transistor 112 to achieve zero-voltage switching. At the third time point T3, the voltage across the primary coil PS is the resonant voltage VCR of the resonant capacitor CR.

From the third time point T3 to the fourth time point T4, the high-side transistor 111 is turned off, and the low-side transistor 112 is turned on under zero-voltage switching. The rectification transistor TR is turned on, causing the output current IOUT to flow through the rectification transistor TR and generate an output voltage VOUT, where the output voltage VOUT is equal to the resonant voltage VCR divided by the number of turns n, as shown in Eq. 1. Furthermore, the primary current IP remains positive and flows into the resonant capacitor CR.

According to some embodiments of the present invention, the leakage inductance of the primary coil PS and the resonant capacitor CR form a resonant tank. The output current IOUT is sinusoidal, and its frequency is determined by the resonant frequency of the resonant circuit. The primary current IP is the magnetizing current IM plus the reflection of the output current IOUT.

From the fourth time point T4 to the fifth time point T5, the high-side transistor 111 remains off, and the low-side transistor 112 remains on. Energy from transformer TM is continuously transferred to the secondary coil SS, and this energy is provided by the resonant capacitor CR. Furthermore, since the low-side transistor 112 remains on, the energy of the resonant capacitor CR is configured to bring the magnetizing current IM to a negative value. According to some embodiments of the present invention, from the fourth time point T4 to the fifth time point T5, the output current IOUT reaches the maximum output current IOM.

At the fifth time point T5, the rectification transistor TR is turned off based on the gate signal SG, thus ending the demagnetization time TDS. From the fifth time point T5 to the sixth time point T6, the resonant capacitor CR continuously reverse-magnetizes the primary coil PS, causing the primary current IP to remain negative until the low-side transistor 112 is turned off.

From the sixth time point T6 to the seventh time point T7, both the high-side transistor 111 and the low-side transistor 112 are turned off. From the fifth time point T5 to the sixth time point T6, the primary current IP, induced as a negative current, turns on the high-side parasitic diode 111D, causing the voltage at the switching node SW to rise to the input voltage VIN. According to some embodiments of the present invention, the second dead time TRH from the sixth time point T6 to the seventh time point T7 is the dead time from the low-side transistor 112 being turned off to the high-side transistor 111 being turned on.

At the seventh time point T7, the high-side driving signal SH is at a high logic level. Since the voltage at the switching node SW rises to the input voltage VIN, the high-side transistor 111 can be turned on in a zero-voltage switching state.

Since the resonant capacitor CR is connected in parallel with the primary coil PS during the demagnetization of the transformer TM, the resonant voltage VCR is the output voltage VOUT multiplied by the turns ratio of the transformer TM. When the difference between the resonant voltage VCR and the voltage value of the output voltage VOUT multiplied by the turns ratio is too large, the drain voltage VD may generate a high voltage spike, reducing the reliability of the rectification transistor TR and even damaging it.

Furthermore, when the difference between the resonant voltage VCR and the voltage value of the output voltage VOUT multiplied by the turns ratio is too large, the maximum output current IOM and the maximum primary current IP during demagnetization of the transformer TM increase significantly, thereby reducing conversion efficiency. To protect circuit components and improve conversion efficiency, it is necessary to optimize the power conversion circuit 100.

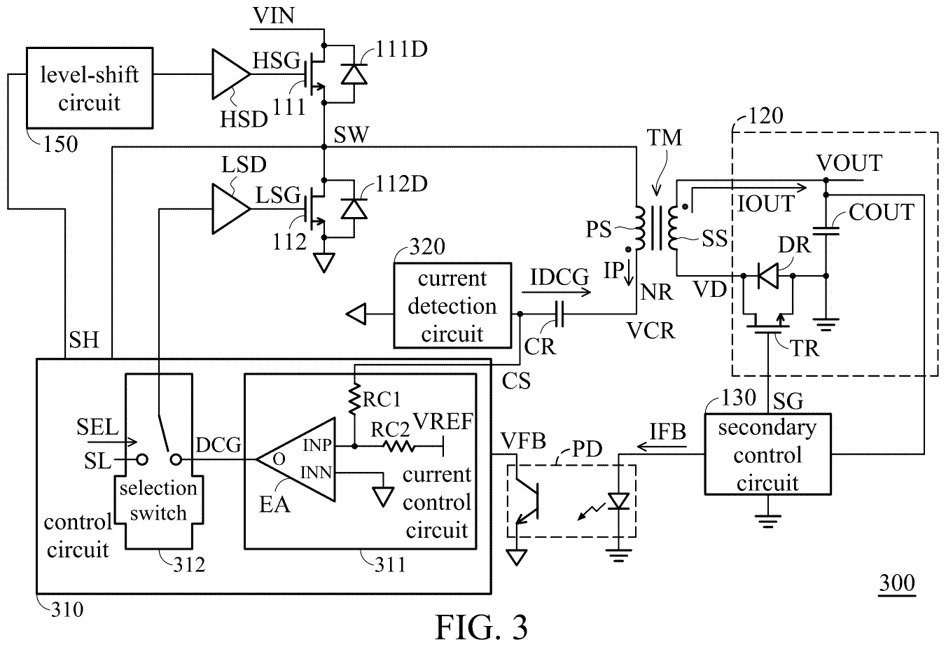

FIG. 3 shows a circuit diagram of a power conversion circuit in accordance with another embodiment of the present invention. Compared to the power conversion circuit 100 in FIG. 1, the power conversion circuit 300 further includes a current detection circuit 310, and the control circuit 140 is replaced by the control circuit 310.

As shown in FIG. 3, the current detection circuit 310 detects the primary current IP and generates a current detection signal CS. The control circuit 310 includes a current control circuit 311 and a selection switch 312. The current control circuit 311 generates a discharge signal DCG based on the current detection signal CS generated by the current detection circuit 310. The selection switch 312 provides either the low-side driving signal SL or the discharge signal DCG to the low-side driving circuit LSD based on the selection signal SEL, thereby driving the low-side transistor 112.

According to an embodiment of the present invention, the current detection circuit 310 detects the discharge current IDCG to generate the current detection signal CS. The current control circuit 311 dynamically adjusts the discharge signal DCG based on the current detection signal CS, so that the discharge current IDCG of the resonant capacitor CR discharged through the low-side transistor 112 is less than a predetermined current. According to some embodiments of the present invention, the predetermined current may be set according to a predetermined discharge period. According to another embodiment of the present invention, the discharge current IDCG may also be controlled to a fixed value. According to some embodiments of the present invention, when the resonant capacitor CR discharges through the low-side transistor 112, the low-side transistor 112 operates in the linear region.

According to an embodiment of the present invention, when the control circuit 310 operates in normal mode, the control circuit 310 provides the low-side driving signal SL to the low-side driving circuit LSD using the selection signal SEL, and drives the high-side transistor 111 and the low-side transistor 112 respectively using the high-side driving signal SH and the low-side driving signal SL, thereby generating an output voltage VOUT in the secondary coil SS.

According to another embodiment of the present invention, when the control circuit 310 operates in discharge mode, the control circuit 310 provides the discharge signal DCG to the low-side driving circuit LSD using the selection signal SEL, so that the resonant capacitor CR discharges through the low-side transistor 112 with a discharge current IDCG.

According to some embodiments of the present invention, when the control circuit 310 operates in normal mode, the current detection circuit 310 detects the primary current IP. When the control circuit 310 operates in discharge mode, the current detection circuit 310 detects the discharge current IDCG.

According to an embodiment of the present invention, when the control circuit 310 receives an input voltage VIN (not shown in FIG. 3), the control circuit 310 executes a startup procedure, and operates in discharge mode during the startup procedure, discharging the resonant capacitor CR with the discharge current IDCG. In other words, when the input voltage VIN is provided to the power conversion circuit 300, the control circuit 310 executes the startup procedure.

According to another embodiment of the present invention, when the control circuit 310 executes a protection mechanism and simultaneously turns off the high-side transistor 111 and the low-side transistor 112, the control circuit 310 operates in discharge mode and discharges the resonant capacitor CR with the discharge current IDCG. According to some embodiments of the present invention, the protection mechanism includes an overcurrent protection, an overvoltage protection, and other protection mechanisms to prevent the power conversion circuit 300 from burning out.

As shown in FIG. 3, the current control circuit 311 includes an error amplifier EA, a first control resistor RC1, and a second control resistor RC2. The error amplifier EA includes a positive input terminal INP, a negative input terminal INN, and an output terminal O. The first control resistor RC1 is coupled between the current detection signal SC and the positive input terminal INP, and the second control resistor RC2 is coupled between the positive input terminal INP and the reference voltage VREF. The negative input terminal INN is coupled to ground, and the output terminal O generates a discharge signal DCG.

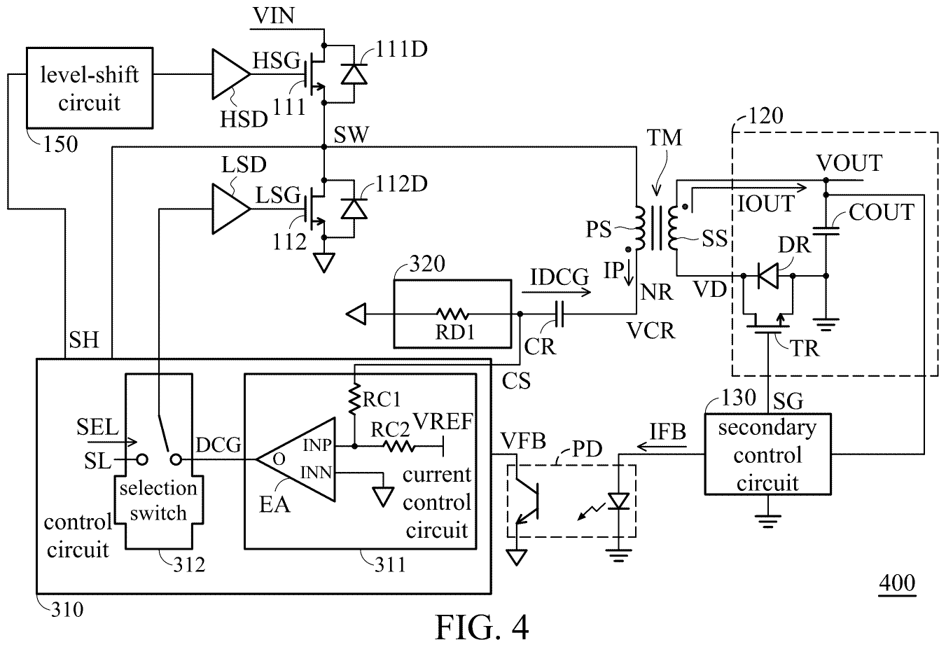

FIG. 4 shows a circuit diagram of a power conversion circuit in accordance with yet another embodiment of the present invention. Compared to the power conversion circuit 300 in FIG. 3, the current detection circuit 320 of the power conversion circuit 400 includes a first detection resistor RD1, where the first detection resistor RD1 is coupled between the resonant capacitor CR and ground.

According to some embodiments of the present invention, when the primary current IP in normal mode and the discharge current IDCG in discharge mode flow through the first detection resistor RD1, the voltage across the first detection resistor RD1 is the current detection signal CS. According to some embodiments of the present invention, since the resistance value of the first detection resistor RD1 is very small, the resonant voltage VCR can be regarded as the voltage across the resonant capacitor CR.

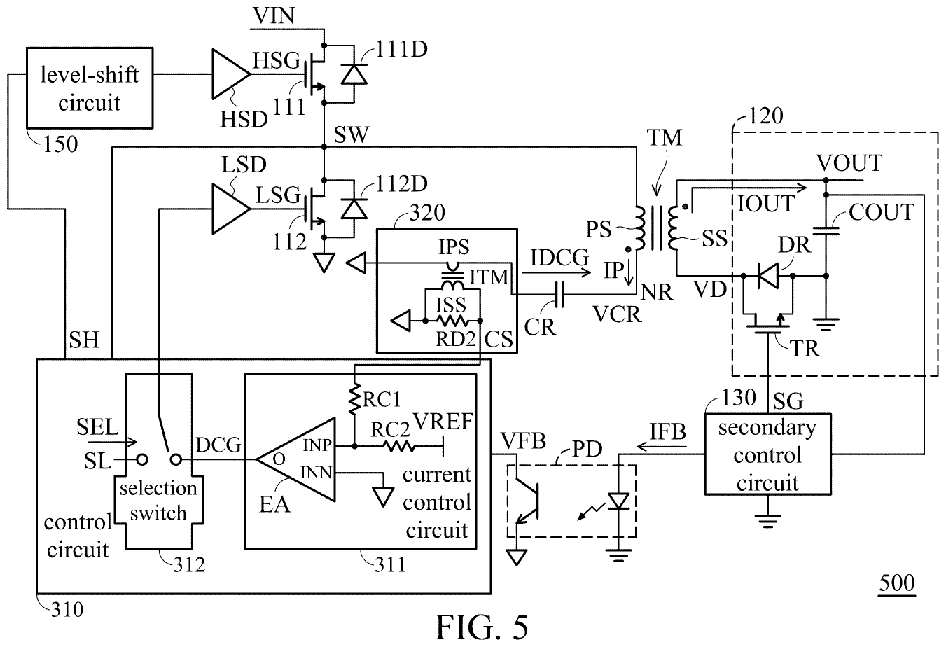

FIG. 5 shows a circuit diagram of a power conversion circuit in accordance with yet another embodiment of the present invention. Comparing the power conversion circuit 500 with the power conversion circuit 300 in FIG. 3, the current detection circuit 320 of the power conversion circuit 500 includes an isolated transformer ITM and a second detection resistor RD2.

The isolated transformer ITM includes an isolated primary coil IPS and an isolated secondary coil ISS, where the isolated primary coil IPS is coupled between the resonant capacitor CR and the ground, and the second detection resistor RD2 is coupled to both terminals of the isolated secondary coil ISS. Furthermore, the voltage across the second detection resistor RD2 generates the current detection signal CS. According to some embodiments of the present invention, the isolated transformer ITM maps the primary current IP or discharge current IDCG flowing through the isolated primary coil IPS to the isolated secondary coil ISS, and a current detection signal CS is generated by a current flowing through the second detection resistor RD2. According to some embodiments of the present invention, since the voltage across the isolated primary coil IPS is very small, the resonant voltage VCR can be considered as the voltage across the resonant capacitor CR.

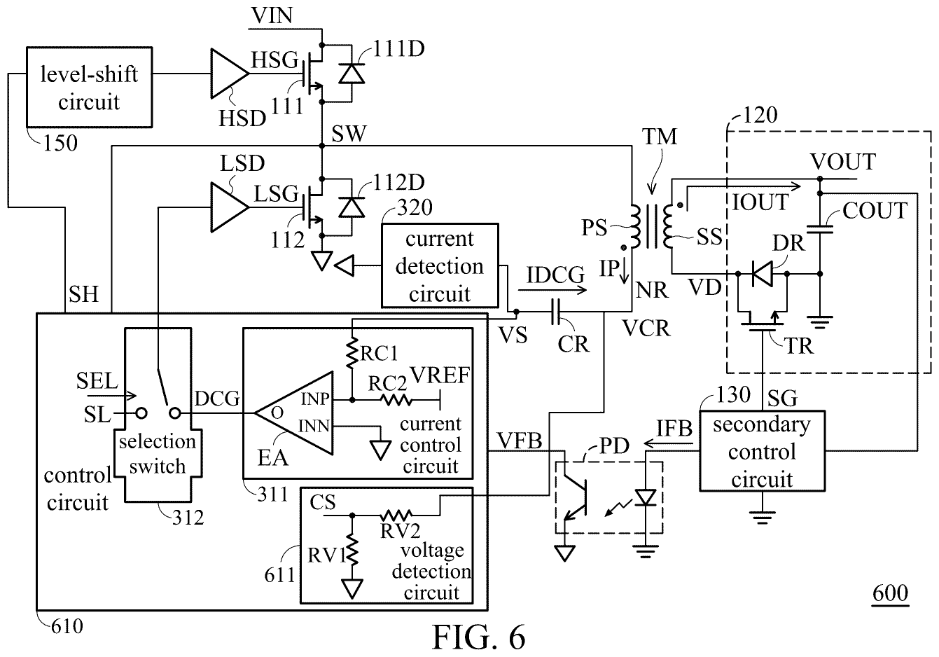

FIG. 6 shows a circuit diagram of a power conversion circuit in accordance with yet another embodiment of the present invention. Compared to the power conversion circuit 300 of FIG. 3, the control circuit 610 of the power conversion circuit 600 further includes a voltage detection circuit 611.

As shown in FIG. 6, the voltage detection circuit 611 is configured to detect the resonant voltage VCR to generate a voltage detection signal VS. In other words, the voltage detection circuit 611 is configured to detect the voltage across the resonant capacitor CR and generate a voltage detection signal VS. In the embodiment of FIG. 6, the voltage detection circuit 611 includes a first voltage-dividing resistor RV1 and a second voltage-dividing resistor RV2, where the first voltage-dividing resistor RV1 and the second voltage-dividing resistor RV2 are configured to divide the resonant voltage VCR to generate a voltage detection signal VS. According to some embodiments of the present invention, the voltage detection signal VS is generated by the voltage-dividing resistor RV2.

According to some embodiments of the present invention, when the control circuit 610 operates in discharge mode, the control circuit 610 determines whether to stop discharging the resonant capacitor CR based on the relationship between the voltage detection signal VS and the output voltage VOUT. According to some embodiments of the present invention, when the voltage-dividing ratio of the first voltage-dividing resistor RV1 and the second voltage-dividing resistor RV2 is equal to the turns ratio of the transformer TM, the control circuit 610 determines whether the voltage detection signal VS is equal to the output voltage VOUT to determine whether to stop discharging the resonant capacitor CR. The turns ratio is equal to the number of turns of the primary coil PS divided by the number of turns of the secondary coil SS.

In other words, when the voltage detection signal VS is less than the output voltage VOUT, the control circuit 610 exits the discharge mode and stops discharging the resonant capacitor CR. When the voltage detection signal VS is not less than the output voltage VOUT, the control circuit 610 continues to operate in the discharge mode and continues to discharge the resonant capacitor CR. According to some embodiments of the present invention, upon exiting the discharge mode, the control circuit 610 may return to the normal mode to generate the output voltage VOUT.

Specifically, when the voltage across the resonant capacitor CR is less than the product of the output voltage VOUT and the turns ratio of the transformer TM, the control circuit 610 stops discharging the resonant capacitor CR. When the voltage across the resonant capacitor CR is not less than the product of the output voltage VOUT and the turns ratio of the transformer TM, the control circuit 610 continues to discharge the resonant capacitor CR.

According to other embodiments of the present invention, the control circuit 610 may also continuously discharge the resonant capacitor CR for a predetermined period and then immediately end the discharge mode. According to some embodiments of the present invention, the predetermined period is not less than the period required for the resonant capacitor CR to discharge to zero. According to some embodiments of the present invention, since the temperature of the low-side transistor 112 will rise when the resonant capacitor CR discharges, the control circuit 610 can intermittently turn on the low-side transistor 112 to control the temperature of the low-side transistor 112, thereby protecting the low-side transistor 112 from burnout.

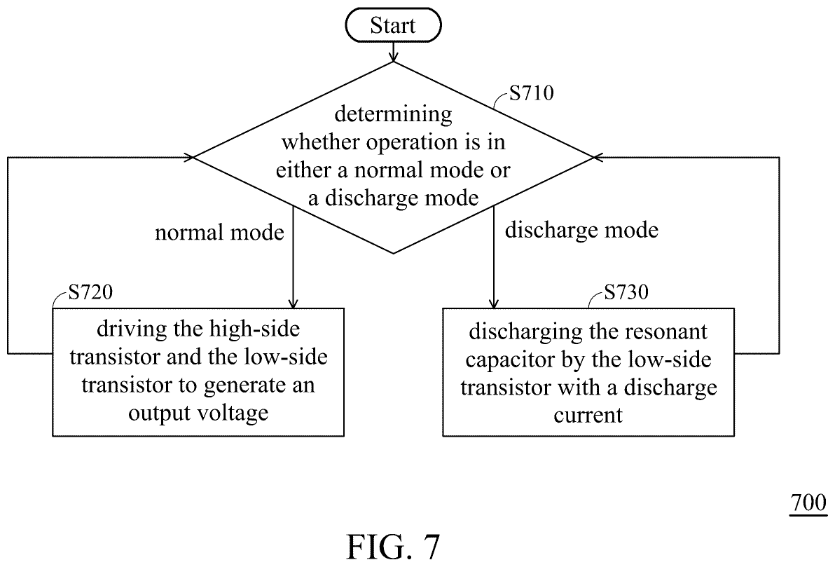

FIG. 7 shows a flowchart of a control method in accordance with an embodiment of the present invention. The following description of the control method 700 will be provided in conjunction with the power conversion circuit 300 in FIG. 3 for detailed explanation.

First, the control circuit 310 determines whether to operate in the normal mode or the discharge mode (step S710). When it is determined to operate in the normal mode, the high-side transistor 111 and the low-side transistor 112 are driven to generate an output voltage VOUT in the secondary coil SS (step S720). When it is determined to operate in the discharge mode, the low-side transistor 112 discharges the resonant capacitor CR with a discharge current IDCG (step S730).

According to an embodiment of the present invention, it is operated in the discharge mode before operating in the normal mode. According to another embodiment of the present invention, when the control circuit 310 receives an input voltage VIN (not shown in FIG. 3), a startup procedure is executed. During the startup procedure, the control circuit 310 operates in the discharge mode. After the startup procedure ends, the control circuit operates in the normal mode.

According to some embodiments of the present invention, after steps S720 and S730, step S710 is re-executed. That is, while operating in either the normal mode or the discharge mode, it continuously determines whether to continue operating in its current mode of operation, or to switch to the other of the normal mode or the discharge mode.

According to yet another embodiment of the present invention, when the control circuit 310 executes a protection mechanism and simultaneously turns off the high-side transistor 111 and the low-side transistor 112, it operates in the discharge mode. When the protection mechanism and the discharge mode end, the control circuit 310 operates in the normal mode. According to some embodiments of the present invention, after step S730, the control circuit 310 returns to step S710 to adjust the discharge signal DCG based on the discharge current IDCG, thereby controlling the on-resistance of the low-side transistor 112 to control the discharge current IDCG to be less than a predetermined current.

According to another embodiment of the present invention, the control circuit 310 may also control the on-resistance of the low-side transistor 112, so that the discharge current IDCG is a fixed value. According to an embodiment of the present invention, when the resonant capacitor CR discharges through the low-side transistor 112, the low-side transistor 112 operates in the linear region.

According to some embodiments of the present invention, when the control circuit 610 operates in the discharge mode, the control circuit 610 further detects the voltage across the resonant capacitor CR, and determines whether to continue to operate in the discharge mode to discharge the resonant capacitor CR based on the relationship between the voltage across the resonant capacitor CR and the output voltage VOUT.

According to an embodiment of the present invention, when the control circuit 610 determines that the voltage across the resonant capacitor CR is less than the product of the output voltage VOUT and the turns ratio, the control circuit 610 exits the discharge mode and stops discharging the resonant capacitor CR. The turns ratio is the number of turns of the primary coil PS divided by the number of turns of the secondary coil SS.

According to another embodiment of the present invention, when the control circuit 610 determines that the voltage across the resonant capacitor CR is not less than the product of the output voltage VOUT and the turns ratio, the control circuit 610 continues to operate in the discharge mode and continuously discharges the resonant capacitor CR.

As shown in the embodiment of FIG. 6, the voltage-dividing ratio of the voltage detection circuit 611 can be adjusted to be equal to the turns ratio. When the voltage detection signal VS is less than the output voltage VOUT, it means that the voltage across the resonant capacitor CR is less than the product of the output voltage VOUT and the turns ratio, and the discharge mode is exited. When the voltage detection signal VS is not less than the output voltage VOUT, it means that the voltage across the resonant capacitor CR is not less than the product of the output voltage VOUT and the turns ratio, and the discharge mode continues.

According to other embodiments of the present invention, when the control circuit 310 operates in the discharge mode, an operation period is counted. When the operation period reaches a predetermined period, the control circuit 310 exits the discharge mode and enters the normal mode, where the predetermined period is not less than the period required for the resonant capacitor CR to discharge to zero. According to some embodiments of the present invention, when operating in the discharge mode, the low-side transistor 112 can be intermittently turned on to control the temperature of the low-side transistor 112.

The present invention provides a power conversion circuit and a control method thereof. When the voltage across the resonant capacitor does not match the output voltage, the resonant capacitor may be discharged through the low-side transistor, helping to reduce the maximum primary current of the primary coil and the maximum output current of the secondary coil. This reduces the conduction losses of the low-side transistor and the rectification transistor, which in turn improves the conversion efficiency under low output voltage and light load conditions. At the same time, it can help to prevent surges in the secondary coil, protecting the circuit components from burnout.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil is coupled between a switching node and a resonant node;
a resonant capacitor, coupled between the resonant node and a ground;
a high-side transistor, providing an input voltage to the switching node based on a high-side driving signal;
a low-side transistor, coupling the switching node to the ground based on a low-side driving signal; and
a control circuit, operating in a normal mode to generate the high-side driving signal and the low-side driving signal so that the secondary coil generates an output voltage;
wherein when the control circuit operates in a discharge mode, the control circuit discharges the resonant capacitor via the low-side transistor with a discharge current.

2. The power conversion circuit as claimed in claim 1, wherein when the control circuit receives the input voltage, the control circuit executes a startup procedure;
wherein, during the startup procedure, the control circuit operates in the discharge mode to discharge the resonant capacitor;
wherein, after the startup procedure, the control circuit operates in the normal mode to generate the output voltage from the secondary coil.

3. The power conversion circuit as claimed in claim 1, wherein when the control circuit executes a protection mechanism to simultaneously turn off the high-side transistor and the low-side transistor, the control circuit operates in the discharge mode to discharge the resonant capacitor.

4. The power conversion circuit as claimed in claim 1, further comprising:
a current detection circuit, configured to detect a primary current flowing through the primary coil and the resonant capacitor to generate a current detection signal;
wherein when the control circuit operates in the discharge mode, the control circuit controls the discharge current to be less than a predetermined current based on the current detection signal.

5. The power conversion circuit as claimed in claim 4, wherein the current detection circuit further comprises:
a first detection resistor, coupled between the resonant capacitor and the ground;
wherein a voltage across the first detection resistor generates the current detection signal.

6. The power conversion circuit as claimed in claim 4, wherein the current detection circuit further comprises:
an isolated transformer, comprising an isolated primary coil and an isolated secondary coil; and
a second detection resistor, coupled to both terminals of the isolated secondary coil;
wherein the isolated primary coil is coupled between the resonant capacitor and the ground;
wherein a voltage across the second detection resistor generates the current detection signal.

7. The power conversion circuit as claimed in claim 4, wherein the control circuit further comprises:
a current control circuit, generating a discharge signal based on a relationship between the current detection signal and a reference voltage; and
a selection switch, providing either the low-side driving signal or the discharge signal to the low-side transistor;
wherein when the control circuit operates in the discharge mode, the selection switch provides the discharge signal to the low-side transistor;
wherein when the control circuit operates in the normal mode, the selection switch provides the low-side driving signal to the low-side transistor.

8. The power conversion circuit as claimed in claim 7, wherein the current control circuit adjusts the discharge signal to control the discharge current to be less than the predetermined current;
wherein when the control circuit operates in the discharge mode, the low-side transistor operates in a linear region.

9. The power conversion circuit as claimed in claim 7, wherein the current control circuit further comprises:
an error amplifier, comprising a positive input terminal, a negative input terminal, and an output terminal;
a first control resistor, coupled between the current detection signal and the positive input terminal; and
a second control resistor, coupled between the positive input terminal and the reference voltage;
wherein the output terminal generates the discharge signal;
wherein the negative input terminal is coupled to the ground.

10. The power conversion circuit as claimed in claim 7, wherein the control circuit further comprises:
a voltage detection circuit, configured to detect a voltage across the resonant capacitor to generate a voltage detection signal;
wherein the voltage detection circuit comprises:
a first voltage-dividing resistor, coupled to the resonant node; and
a second voltage-dividing resistor, coupled between the first voltage-dividing resistor and the ground;
wherein a voltage across the second voltage-dividing resistor generates the voltage detection signal.

11. The power conversion circuit as claimed in claim 10, wherein when the control circuit operates in the discharge mode, the control circuit determines whether to stop discharging the resonant capacitor based on the relationship between the voltage detection signal and the output voltage;
wherein when the control circuit determines to stop discharging the resonant capacitor, the selection switch provides the low-side driving signal to the low-side transistor.

12. The power conversion circuit as claimed in claim 10, wherein the control circuit determines the relationship between the voltage across the resonant capacitor and the output voltage based on the voltage detection signal;
wherein when a voltage across the resonant capacitor is less than a product of the output voltage and a turns ratio, the control circuit exits the discharge mode;
wherein when the voltage across the resonant capacitor is not less than the product of the output voltage and the turns ratio, the control circuit continues in the discharge mode;
wherein the turns ratio is equal to number of turns of the primary coil divided by number of turns of the secondary coil.

13. The power conversion circuit as claimed in claim 1, wherein when the control circuit operates in the discharge mode over a predetermined period, the control circuit exits the discharge mode to stop discharging the resonant capacitor;
wherein when the control circuit operates in the discharge mode, the control circuit intermittently turns on the low-side transistor to control a temperature of the low-side transistor.

14. A control method for controlling a power conversion circuit, wherein the power conversion circuit comprises a resonant capacitor coupled between a resonant node and a ground, a transformer comprising a primary coil and a secondary coil, a high-side transistor providing an input voltage to a switching node, and a low-side transistor coupling the switching node to the ground, wherein the primary coil is coupled between the switching node and the resonant node, wherein the control method comprises:
determining whether to operate in a normal mode or a discharge mode;
driving the high-side transistor and the low-side transistor to generate an output voltage from the secondary coil when it is determined to operate in the normal mode; and
discharging the resonant capacitor via the low-side transistor with a discharge current when it is determined to operate in the discharge mode.

15. The control method as claimed in claim 14, wherein the step of determining whether to operate in the normal mode or the discharge mode further comprises:
before operating in the normal mode, operating in the discharge mode.

16. The control method as claimed in claim 14, wherein the step of determining whether to operate in the normal mode or the discharge mode further comprises:
when the input voltage is received, executing a startup procedure;
during the startup procedure, operating in the discharge mode; and
when the startup procedure ends, operating in the normal mode.

17. The control method as claimed in claim 14, wherein the step of determining whether to operate in the normal mode or the discharge mode further comprises:
when executing a protection mechanism to simultaneously turn off the high-side transistor and the low-side transistor, operating in the discharge mode; and
when the protection mechanism ends, operating in the normal mode.

18. The control method as claimed in claim 14, wherein the step of discharging the resonant capacitor via the low-side transistor with the discharge current when it is determined to operate in the discharge mode further comprises:
detecting the discharge current to generate a current detection signal; and
controlling the low-side transistor based on the current detection signal so that the discharge current is less than a predetermined current.

19. The control method as claimed in claim 18, wherein the step of discharging the resonant capacitor via the low-side transistor with the discharge current when it is determined to operate in the discharge mode further comprises:
generating a discharge signal based on a relationship between the current detection signal and a reference voltage using an error amplifier; and
controlling the low-side transistor using the discharge signal so that the discharge current is less than the predetermined current;
wherein the low-side transistor operates in a linear region when it is determined to operate in the discharge mode.

20. The control method as claimed in claim 18, wherein the step of discharging the resonant capacitor via the low-side transistor with the discharge current when it is determined to operate in the discharge mode further comprises:
detecting a voltage across the resonant capacitor to generate a voltage detection signal;
determining whether to continue to discharge the resonant capacitor based on a relationship between the voltage across the resonant capacitor and the output voltage;
stopping discharging the resonant capacitor when the voltage across the resonant capacitor is less than a product of the output voltage multiplied by a turns ratio; and
continuing to discharge the resonant capacitor when the voltage across the resonant capacitor is not less than the product of the output voltage multiplied by the turns ratio;
wherein the turns ratio is equal to the number of turns of the primary coil divided by the number of turns of the secondary coil.
